(19) United States
(12) Patent Application Publication
(10) Pub. No.: US 2011/0143262 A1
(43) Pub. Date: Jun. 16, 2011

(54) GAS DIFFUSION MEDIA MADE FROM ELECTRICALLY CONDUCTIVE COATINGS ON NON-CONDUCTIVE FIBERS

(75) Inventors: Derek W. Fultz, Rochester, NY (US); Paul D. Nicotera, Honeoye Falls, NY (US); Thomas A. Trabold, Pittsford, NY (US); Gayatri Vyas Dadheech, Rochester Hills, MI (US); Po-Ya Abel Chuang, Victor, NY (US)

(73) Assignee: GM GLOBAL TECHNOLOGY OPERATIONS, INC., Detroit, MI (US)

(21) Appl. No.: 12/635,352

(22) Filed: Dec. 10, 2009

(51) Int. Cl. H01M 8/10; B05D 5/12; B05D 1/04; C25D 5/00

(52) U.S. Cl. 429/513; 427/115; 427/458; 205/80; 429/523; 429/525

(57) ABSTRACT

A fuel cell includes a first electrically conductive plate and a first gas diffusion layer. The first gas diffusion layer is disposed over the first electrically conductive plate. Characteristically, the first gas diffusion layer comprises a first fibrous sheet having fibers coated with an electrically conductive layer. A first catalyst layer is disposed over the first gas diffusion layer and an ion conducting membrane is disposed over the first catalyst layer. The fuel cell also includes a second catalyst layer disposed over the ion conducting membrane with a second gas diffusion layer disposed over the second catalyst layer. A second electrically conductive plate is disposed over the second gas diffusion layer. Methods for forming the gas diffusion layers and the fuel cell are also provided.

### TECHNICAL FIELD

The present invention relates to gas diffusion media for fuel cell applications.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ion conductive polymer membrane to the cathode where they combine with oxygen to form water which is discharged from the cell. Typically, the ion conductive polymer membrane includes a perfluorosulfonic acid (PFSA) ionomer.

The MEA is sandwiched between a pair of porous gas diffusion layers (“GDL”), which in turn are sandwiched between a pair of electrically conductive elements or plates. The plates function as current collectors for the anode and the cathode; and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

Gas diffusion layers play a multifunctional role in PEM fuel cells. For example, GDL act as diffusers for reactant gases traveling to the anode and the cathode layers, while transporting product water to the flow field. GDL also conduct electrons and transfer heat generated at the MEA to the coolant, and act as a buffer layer between the soft MEA and the stiff bipolar plates. Typically, the gas diffusion layers are formed from a carbon fabric or a nonwoven fabric with or without a microporous layer attached thereto. Although the current technologies for making gas diffusion layers works reasonably well, the construction of these fuel cell components tend to be relatively expensive.

Accordingly, there is a need for alternative methods and compositions for forming gas diffusion layers for fuel cell applications.

### SUMMARY OF EXEMPLARY EMBODIMENTS OF THE INVENTION

The present invention solves one or more problems of the prior art by providing in at least one embodiment a fuel cell that includes a diffusion medium having fibers coated with an electrically conductive layer. The fuel cell of this embodiment includes a first electrically conductive plate and a first gas diffusion layer. The first gas diffusion layer is disposed over the first electrically conductive plate. Characteristically, the first gas diffusion layer comprises a first fibrous sheet having fibers coated with an electrically conductive layer. A first catalyst layer is disposed over the first gas diffusion layer and an ion conducting membrane is disposed over the first catalyst layer. The fuel cell also includes a second catalyst layer disposed over the ion conducting membrane with a second gas diffusion layer disposed over the second catalyst layer. A second electrically conductive plate is disposed over the second gas diffusion layer.

In another embodiment of the present invention, a method for making the diffusion media set forth above is provided. The method of this embodiment includes a step in which at least a portion of a plurality of fibers are coated with an electrically conductive layer to form a plurality of coated fibers. This plurality of coated fibers is used to form a gas diffusion layer for fuel cell applications. In an optional step, a microporous layer is applied to the gas diffusion layer.

In another embodiment of the present invention, a method for assembling a fuel cell is provided. The method of this embodiment includes a step in which the gas diffusion layer set forth above is placed between an electrically conductive plate and a membrane electrode assembly (MEA). A second gas diffusion layer is placed between the membrane electrode assembly and a second electrically conductive plate.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell that incorporates a gas diffusion layer of one or more embodiments of the invention;

FIG. 2 is a flow chart providing a first variation of a method for forming a gas diffusion layer;

FIG. 3 is a flow chart providing another variation of a method for forming a gas diffusion layer; and

FIG. 4 is a flow chart providing a variation of a method for forming a fuel cell incorporating gas diffusion layers comprising fibers coated with an electrically conductive layer.

### DETAILED DESCRIPTION OF EXEMPLARY EMBODIMENTS

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

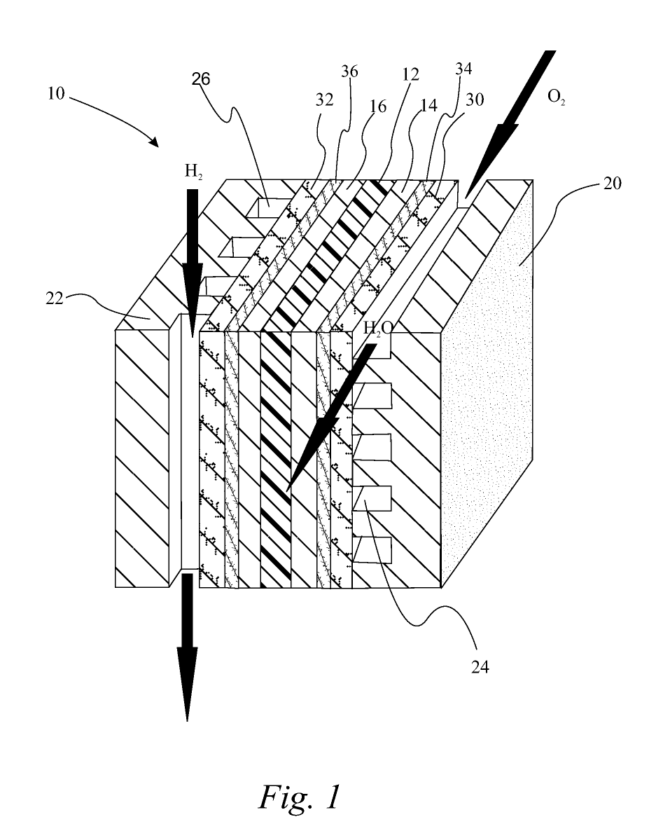

With reference to FIG. 1, a fuel cell that incorporates a gas diffusion medium of one or more embodiments of the invention is provided. PEM fuel cell 10 includes polymeric ion conductive membrane 12 disposed between first catalyst layer 14 and second catalyst layer 16. In a variation, first catalyst layer 14 is a cathode layer and second catalyst layer 16 is an anode layer. Fuel cell 10 also includes electrically conductive plates 20, 22 and gas channels 24 and 26. Gas diffusion layer 30 is interposed between electrically conductive plate 20 and first catalyst layer 14, and gas diffusion layer 32 is interposed between electrically conductive plate 22 and second catalyst layer 16. One or both of gas diffusion layers 30 and 32 includes fibers coated with an electrically conductive layer as set forth below in more detail. In various refinements, one or both of gas diffusion layers 30 and 32 include a woven or non-woven sheet of coated fibers.

Still referring to FIG. 1, in a variation of the present embodiment, microporous layer 34 is interposed between gas diffusion layer 30 and first catalyst layer 14, and microporous layer 36 is interposed between gas diffusion layer 32 and second catalyst layer 16.

Diffusion layers 30 and 32 each include fibers that are coated with an electrically conductive layer as set forth above. In a refinement, the fibers include electrically non-conductive fibers. Examples of such fibers include, but are not limited to, glass fibers, polymeric fibers, ceramic fibers, and combinations thereof. More specific examples of useful fibers include, but are not limited to, polyamide fibers, nylon fibers, polyester fibers, phenol-formaldehyde fibers, polyvinyl alcohol fibers, polyvinyl chloride fibers, polyolefin fibers, acrylic fibers, polyacrylonitrile fibers, aromatic polyamide fibers, polyethylene fibers, polyurethane fibers, boron-containing E-glass (silica-calcia-alumina-boric oxide) fibers, boron-free E-glass (silica-calcia-alumina-magnesium oxide) fibers, D-glass (silica-boric oxide-alumina-calcia-magnesium oxide and silica-boric oxide-sodium oxide) fibers, silica/quartz fibers, and combinations thereof. It should be appreciated that the present invention also contemplates using electrically conductive fibers. In such an instance, the electrically conductive layer is used to improve the electrical conductivity of the fibers.

In a variation of the present embodiment, the fibers that are coated with an electrically conductive layer have lengths from about 3 mm to about 65 mm. Longer fibers are usually desirable to increase percolation and conductivity. However, longer fibers tend to make processing more difficult and in fuel cell applications can potentially increase the probability of membrane failure. Therefore, fiber lengths of about 6 mm are acceptable. In another refinement, fiber diameters are from about 5 microns to about 15 microns. For a good balance between packing density and fiber strength, a fiber diameter from about 7 to 10 micron is acceptable.

As set forth above, gas diffusion layers 30 and 32 include fibers that are coated with an electrically conductive layer. Examples of electrically conductive material that can be included in these layers include, but are not limited to, metal films (e.g., gold, platinum, ruthenium, iridium, nickel, steel, chromium, palladium, nichrome etc), carbon films, metal carbide films, electrically conducting oxide films (e.g., indium tin oxide, fluorine or antimony doped tin oxide, niobium or tantalum doped titanium oxide etc), oxynitride films (e.g., titanium oxynitride, vanadium oxynitride, etc), and combinations thereof. In a refinement of the present embodiment, the electrically conductive layer has a thickness from about 1 nm to about 1 micron.

The concept of coating nonconductive fibers with a conductive coating is proposed as a means of replicating the electrical properties of relatively expensive gas diffusion media materials at significantly lower cost. For a conductive fiber with resistance per length of (R/L)_{c}, conductive coating resistivity of ρₘ, and nonconductive fiber diameter of d_{nc}, the coating thickness (t_{c}) needed to match the conductive fiber electrical properties may be computed by:

$${t}_{c} = \sqrt{\frac{{ρ}_{m}}{{π ( \frac{R}{L} )}_{c}} + ( \frac{{d}_{nc}}{2} )} - \frac{{d}_{nc}}{2}$$

An example of the calculation of the above formula is as follows. A gas diffusion medium is comprised of carbon fibers of 7 μm diameter and resistivity of 2000 μΩcm. Based on these values, the conductive fiber resistance per length is (R/L)_{c} is 5.2×10⁹ μΩ/cm. Various conductive materials having resistivity much lower than the base carbon fiber could be applied to an essentially nonconductive fiber with diameter of 10 μm to replicate the electrical properties of the standard gas diffusion medium:

| Material | Resistivity (μΩ cm) | Required coating thickness (nm) |
|---|---|---|
| Gold | 2.2 | 1.3 |
| Tungsten | 5.4 | 3.3 |
| Titanium | 70 | 42.7 |
| Titanium | 100 | 60.9 |
| oxynitride | | |

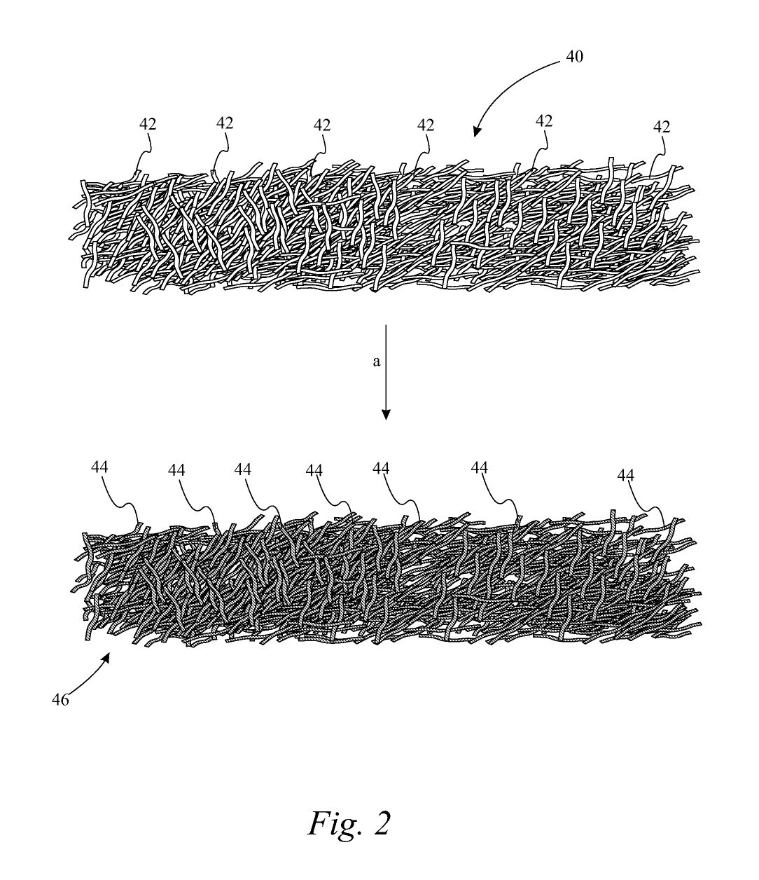

With reference to FIG. 2, a method of forming a gas diffusion medium for fuel cell applications is provided. First fibrous substrate 40 includes a plurality of fibers 42. In one refinement, fibrous substrate 40 is formed by a wet-laid process using a binder (e.g., PVA) to hold the fibers together). In another refinement, fibrous substrate 40 is formed by a dry-laid process in which the fibers are held together by physical entanglement (e.g., needling or water jet spraying, called “hydroentangling”) or a non-woven process. In step a), fibrous substrate 40 is coated with an electrically conductive material to form a plurality of coated fibers 44 which form gas diffusion layers 30 and/or 32. In addition to rendering the fibers electrically conductive, the electrically conducting layer may enhance electrical continuity and improve fiber binding if an appropriately penetrating coating process is used (e.g., chemical vapor deposition, dip coating, etc.).

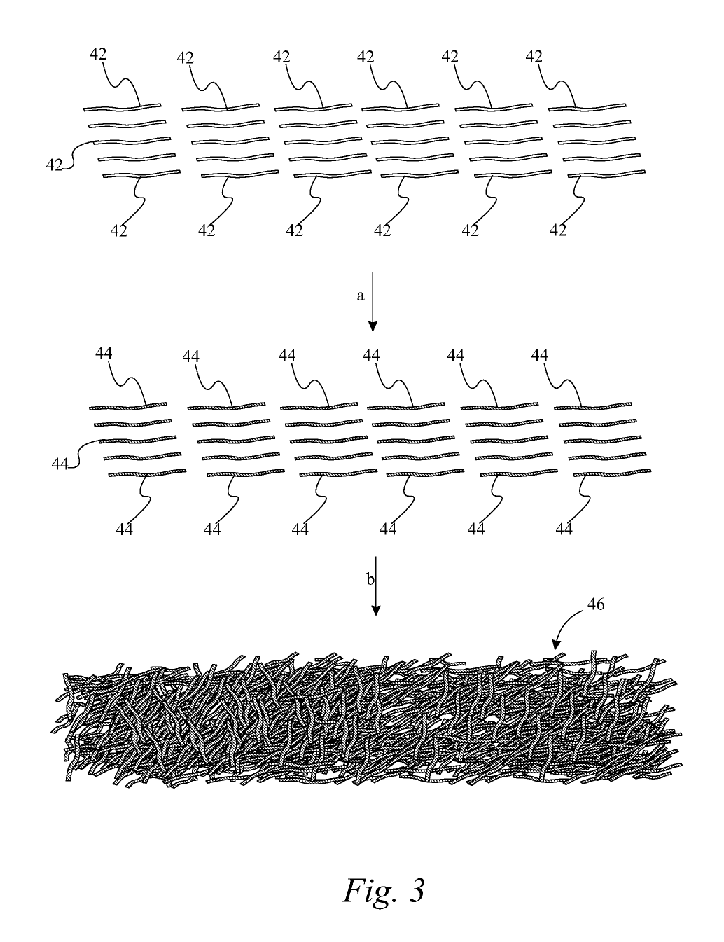

With reference to FIG. 3, a method of forming a gas diffusion medium for fuel cell applications is provided. Fibers 42 are first coated in step a) with an electrically conductive material to form a plurality of coated fibers 44. Plurality of coated fibers 44 are then formed into a fibrous substrate 46 in step b). Fibrous substrate 46 may be formed by any number of methods known to those skilled in the art of making gas diffusion layers for fuel cells. For example, fibrous substrate 46 is formed either by binding the fibers with conventional carbonized resins, or somehow using the conductive coating (i.e., by melting/fusing, diffusion bonding, etc.) to bind the fibers together.

In each of the methods depicted by FIGS. 2 and 3, fibers are coated with a conductive layer. In one variation, the fibers are coated by a physical deposition process such as sputtering or evaporation. In another variation, a chemical method in which a chemical reaction occurs is used to apply the electrically conductive layer to the fibers. Examples of chemical methods include, but are not limited to, chemical vapor deposition, atomic layer deposition (ALD), chemical vapor infiltration (CVI) and spray pyrolysis. Chemical vapor deposition uses the reaction of gaseous reactants at elevated temperatures to deposit an electrically conductive film. For example, as set forth in U.S. Pat. No. 5,286,520, tin tetrachloride is reacted with water in the presence of a fluorocarbon at elevated temperature to form a conductive fluorine doped tin oxide film. The entire disclosure of this patent is hereby incorporated by reference. Atomic layer deposition is a vapor phase chemical process that typically uses two or more sequentially deposited chemical precursors such that the surface chemistry interactions force the layer to be conformal and a controlled thickness. Chemical vapor infiltration uses electromagnetic fields with carefully controlled reactant concentrations and temperature profiles within a reaction chamber to achieve uniform and penetrating coatings. In another embodiment, the conductive layer is applied by a dip coating method. In one variation, a sheet is dip coated (FIG. 2). In a refinement of this variation, a dipping method with carbon precursor dispersion and subsequent low temperature carbonization is deployed to form a conductive film.

In another variation, the fibers of FIGS. 2 and 3 are coated by electroplating, electroforming, and electrostatic deposition. In one variation of electroforming, a sacrificial template/mold is used as a basis for the diffusion material metal “fiber” shape. For example, a plastic “mesh” is coated with a conductive layer and then optionally the plastic is melted away. In another variation, conductive particles are coated onto non-conductive fibers and then fused in order to form a continuous film by sintering the particles.

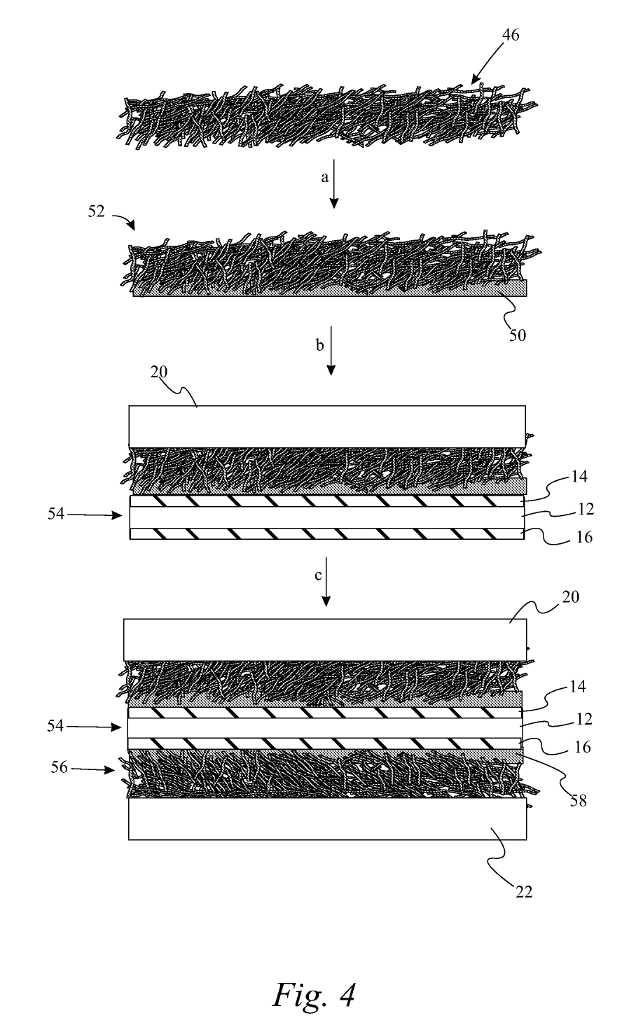

With reference to FIG. 4, a method for assembling a fuel cell incorporating the gas diffusion media set forth above is provided. Fibrous substrate 46 includes a plurality of fibers coated with an electrically conductive layer. Microporous layer 50 is applied to fibrous substrate 46 in step a) to form composite layer 52. Microporous layer 50 is formed by applying a microlayer composition (e.g., an ink or paste) to fibrous substrate 46. In a refinement, the microlayer composition includes carbon particles (e.g., carbon black), a fluorocarbon polymer, and an optional solvent. After the microlayer composition is applied to fibrous substrate 46, the microlayer composition is cured at an elevated temperature to effectuate bonding of the microlayer to the substrate. In step b), composite layer 52 is placed between electrically conductive plate 20 and membrane electrode assembly 54. Finally, the construction of the fuel cell is completed by placing gas diffusion medium 56 between electrically conductive plate 22 and membrane electrode assembly 54. In a variation of the present embodiment, the gas diffusion layer 56 includes a plurality of fibers coated with an electrically conductive layer as set forth above. In a further variation, microporous layer 58 is applied to gas diffusion layer 56 as set forth above.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fuel cell comprising:
a first electrically conductive plate;
a first gas diffusion layer disposed over the first electrically conductive plate, the first gas diffusion layer comprising a first fibrous sheet having fibers coated with an electrically conductive layer;
a first catalyst layer disposed over the first gas diffusion layer;
an ion conducting membrane disposed over the first catalyst layer;
a second catalyst layer disposed over the ion conducting layer;
a second gas diffusion layer disposed over the second catalyst layer; and
a second electrically conductive plate disposed over the second gas diffusion layer.

2. The fuel cell of claim 1 wherein a first microporous layer is interposed between the first diffusion layer and the first catalyst layer, and a second microporous layer is interposed between the second catalyst layer and the second gas diffusion layer.

3. The fuel cell of claim 2 wherein the first and second microporous layers each independently comprise carbon black and PTFE particles.

4. The fuel cell of claim 1 wherein the fibers comprise electrically non-conductive fibers.

5. The fuel cell of claim 1 wherein the fibers comprise a component selected from the group consisting of glass fibers, polymeric fibers, ceramic fibers, and combinations thereof.

6. The fuel cell of claim 1 wherein the fibers are selected from the group consisting of polyamide nylon, polyester fibers, phenol-formaldehyde fibers, polyvinyl alcohol fibers, polyvinyl chloride fibers, polyolefin fibers, acrylic fibers, polyacrylonitrile fibers, aromatic polyamide fibers, polyethylene fibers, polyurethane fibers, and combinations thereof.

7. The fuel cell of claim 1 wherein the electrically conductive layer comprises a component selected from the group consisting of metal films, carbon films, conducting oxide films, oxynitride films, and combinations thereof.

8. The fuel cell of claim 1 wherein the electrically conductive layer has a thickness from about 1 nm to about 1 micron.

9. The fuel cell of claim 1 wherein the fibrous sheet is woven or non-woven.

10. The fuel cell of claim 1 wherein the second gas diffusion layer comprises a second fibrous sheet having fibers coated with an electrically conductive layer.

11. A fuel cell comprising:
a first electrically conductive plate;
a first gas diffusion layer disposed over the first electrically conductive plate, the gas diffusion layer comprising a fibrous sheet having non-electrically conductive fibers coated with an electrically conductive layer;
a first catalyst layer disposed over the first gas diffusion layer;
an ion conducting membrane disposed over the first catalyst layer;
a second catalyst layer disposed over the ion conducting layer;
a second gas diffusion layer disposed over the second catalyst layer, the gas diffusion layer comprising a fibrous sheet having non-electrically conductive fibers coated with an electrically conductive layer; and
a second electrically conductive plate disposed over the second gas diffusion layer.

12. The fuel cell of claim 11 wherein the fibers comprise a component selected from the group consisting of fiberglass fibers, plastic fibers, ceramic fibers, and combinations thereof.

13. The fuel cell of claim 11 wherein the fibers are selected from the group consisting of polyamide nylon, polyester fibers, phenol-formaldehyde fibers, polyvinyl alcohol fibers, polyvinyl chloride fibers, polyolefin fibers, acrylic fibers, polyacrylonitrile fibers, aromatic polyamide fibers, polyethylene fibers, polyurethane fibers, and combinations thereof.

14. The fuel cell of claim 11 wherein the electrically conductive layer comprises a component selected from the group consisting of metal films, carbon films, conducting oxide films, and combinations thereof.

15. The fuel cell of claim 11 wherein the electrically conductive layer has a thickness from about 1 nm to about 1 micron.

16. A method of making a fuel cell comprising a first electrically conductive plate, a first gas diffusion layer disposed over the first electrically conductive plate, a first catalyst layer disposed over the first gas diffusion layer, an ion conducting membrane disposed over the first catalyst layer, a second catalyst layer disposed over the ion conducting layer, a second gas diffusion layer disposed over the second catalyst layer, and a second metal plate disposed over the second gas diffusion layer, the method comprising:
providing a plurality of fibers;
coating at least a portion of the plurality of fibers with an electrically conductive layer to form a plurality of coated fibers; and
placing the plurality of coated fibers between the first conductive plate and the first catalyst layer.

17. The method of claim 16 wherein the fibers are coated by physical deposition.

18. The method of claim 16 wherein the fibers are coated by evaporation.

19. The method of claim 16 wherein the fibers are coated by chemical vapor deposition, atomic layer deposition, and chemical vapor infiltration.

20. The method of claim 16 wherein the fibers are coated by dip coating.

21. The method of claim 16 wherein the fibers are coated by electroplating, electroforming, and electrostatic deposition.

22. The method of claim 16 wherein the fibers are coated by spray pyrolysis.

23. The method of claim 16 further comprising:
a second fibrous sheet having a plurality of fibers;
coating at least a portion of the fibers in the second fibrous sheet with an electrically conductive layer; and
placing the second fibrous sheet between the second conductive plate and the second catalyst layer.
